(19) United States
(12) Patent Application Publication
(10) Pub. No.: US 2022/0152930 A1
(43) Pub. Date: May 19, 2022

(54) ADDITIVE MANUFACTURING SPREADER WITH A CLEANER

(71) Applicant: Hewlett-Packard Development Company, L.P., Spring, TX (US)

(72) Inventors: Guillermo Moliner Clemente, Sant Cugat del Valles (ES); Eduard Galdeano Castillo, Sant Cugat del Valles (ES); Alejandro Torres Pinero, Sant Cugat del Valles (ES)

(73) Assignee: Hewlett-Packard Development Company, L.P., Spring, TX (US)

(21) Appl. No.: 17/416,147

(22) PCT Filed: Aug. 5, 2019
(86) PCT No.: PCT/US2019/045066

§ 371 Date: Jun. 18, 2021

(51) Int. Cl. B29C 64/35; B33Y 50/02; B33Y 30/00; B33Y 40/00; B29C 64/218; B29C 64/393; B29C 64/165; B28B 1/00; B22F 12/63

(52) U.S. Cl. CPC B29C 64/35; B33Y 50/02; B33Y 30/00; B33Y 40/00; B22F 12/63; B29C 64/393; B29C 64/165; B28B 1/001; B29C 64/218

(57) ABSTRACT

A spreading system for an additive manufacturing machine. The system has a roller rotatable about a rotary axis and having an exterior cylindrical surface to spread build material. A sensor senses material attached to the exterior cylindrical surface of the roller. A cleaning member abuts the exterior cylindrical surface of the roller and removes attached material therefrom. A controller rotates the roller whilst in abutment with the cleaning member in response to the sensor sensing material attached to the exterior cylindrical surface of the roller.

### BACKGROUND

Additive manufacturing machines produce 3D objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into slices each defining that part of a layer or layers of build material to be formed into the object. Build material may comprise any suitable form of build material, for example fibres, granules or powders. The build material can include thermoplastic materials, ceramic material and metallic materials.

### BRIEF DESCRIPTION OF THE DRAWINGS

Some non-limiting examples of the present disclosure will be described in the following with reference to the appended drawings in which:

FIG. 1 is a schematic end view of a spreading system of an additive manufacturing machine in accordance with aspects of the present disclosure;

FIG. 2 is a perspective view of a spreading system of an additive manufacturing machine in accordance with aspects of the present disclosure;

FIG. 3 is a perspective view of a moveable spreader and sensor of a spreading system of an additive manufacturing machine in accordance with aspects of the present disclosure;

FIG. 4 is a schematic cross-sectional end view of a spreader of an additive manufacturing machine in accordance with aspects of the present disclosure, wherein the spreader is clean;

FIG. 5 is a schematic cross-sectional end view of a spreader of an additive manufacturing machine in accordance with aspects of the present disclosure, wherein the spreader has material attached thereto which is to be removed;

FIG. 6 is a cross-sectional end view of a spreading system of an additive manufacturing machine in accordance with aspects of the present disclosure, wherein a cleaning member is in a stored position; and

FIG. 7 is a cross-sectional end view of a spreading system of an additive manufacturing machine in accordance with aspects of the present disclosure, wherein a cleaning member is in an active position.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some additive manufacturing processes, a binder is used to bind together particles of a powdered build material to form a solid object. The printing begins with a process of spreading the powdered build material on to the surface of a print area. A powder bed is thereby provided which covers a printing zone. Binder is then jetted at precise locations on to the powder bed to define the geometry of the single or multiple parts to be printed. The process then continues with an energy source assisting with the evaporation of liquid components. This process is repeated until the part or parts are formed layer by layer.

The process is undertaken by an additive manufacturing machine having, for example, two carriages. The first carriage has a roller or spreader that spreads the powder on the top of the print area surface to thereby provide successive layers of powder bed covering a build platform. The roller presses the powder with the aim of maximizing the plane surface. The spreader is metal based. The second carriage has a print nozzle and energy emitter. The print nozzle jets binder at precise locations on to the powder bed to define the geometry of the single or multiple parts to be printed. The energy emitter assists with the evaporation of liquid components of the binder.

In a different example, the process is undertaken by an additive manufacturing machine having one carriage which performs the functions of the two carriages mentioned above. These functions are performed in the same single pass of the carriage over the print area. In a yet further example having one carriage, the functions are performed in more than one pass of the carriage.

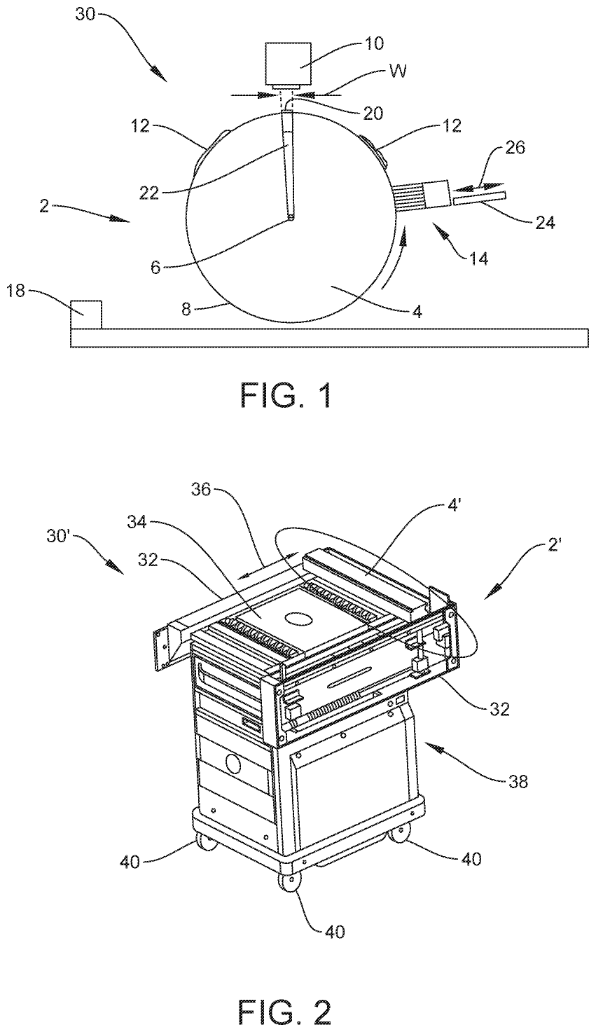

FIG. 1 shows a schematic end view of a spreading system 2 of an additive manufacturing machine 30. The spreading system 2 has a spreader, which is a roller 4 rotatable about a rotary axis 6 and having an exterior cylindrical surface 8 to spread build material. A sensor 10 to sense material 12 attached to the exterior cylindrical surface 8 of the roller 4 is provided. Also provided is a cleaning member 14 to abut the exterior cylindrical surface 8 of the roller 4 and remove attached material therefrom. The cleaning member 14 is moved, when controlled to do so, to abut the exterior cylindrical surface 8 of the roller 4 and remove attached material therefrom. Furthermore, the spreading system 2 has a controller 18 to control the roller 4 to rotate the roller 4 whilst in abutment with the cleaning member 14 in response to the sensor 10 sensing material 12 attached to the exterior cylindrical surface 8 of the roller 4.

The controller 18 controls the roller 4 to rotate the roller 4 in response to the sensor 10 sensing material 12 attached to the exterior cylindrical surface 8 of the roller 4 in excess of a predetermined threshold amount of attached material. In one example, the predetermined threshold amount of attached material is an area of the exterior cylindrical surface 8 of the roller 4 covered by attached material in the range of 5% to 15% of the total area of the exterior cylindrical surface 8 of the roller 4.

The controller 18 controls the roller 4 to rotate the roller 4 through 360 degrees to determine whether material 12 attached to the exterior cylindrical surface 8 of the roller is in excess of the predetermined threshold amount of attached material.

The sensor 10 senses material 12 located in an elongate field of view 20 of the sensor 10, the field of view 20 having a length L at least the length of the roller 4 and wherein the controller 18 controls the roller 4 to rotate the exterior cylindrical surface 8 of the roller 4 through the field of view 20 to determine the amount of material 12 attached to the exterior cylindrical surface 8. In a different example, the field of view has a length L less than the length of the roller 4.

The elongate field of view 20 of the sensor has a width (W) equal in dimension to a circumferential portion of the exterior cylindrical surface 8 which, in one example, extends through an arc 22 of between 1 and 3 degrees.

The spreading system 2 also has a cleaning member actuator 24 to move the cleaning member between a first position, in which the cleaning member 14 is stored, and a second position, in which a brush 14 abuts the exterior cylindrical surface 8 of the roller 4.

The cleaning member actuator 24 moves the cleaning member 14 from the first position to the second position, or retains the cleaning member in the second position, in response to the sensor 10 sensing material 12 attached to the exterior cylindrical surface 8 of the roller 4 in excess of the predetermined threshold amount of attached material.

The cleaning member actuator 24 moves the cleaning member 14 from the second position to the first position, or retains the cleaning member in the first position, in response to the sensor 10 sensing material 12 attached to the exterior cylindrical surface 8 of the roller 4 is at or below the predetermined threshold amount of attached material.

The sensor 10 senses material 12 attached to the exterior cylindrical surface 8 of the roller 4 while the controller 18 controls the roller to rotate the roller 4 in abutment with the cleaning member 14. The cleaning member actuator 24 moves the cleaning member 14 from the second position to the first position in response to the sensor 10 sensing material 12 attached to the exterior cylindrical surface 8 of the roller 4 is at or below the predetermined threshold amount of attached material.

As shown in FIG. 1, the cleaning member 14 is located to the side of the exterior cylindrical surface 8 of the roller. In an alternative example, the cleaning member 14 is located above the exterior cylindrical surface 8 of the roller 4. In a yet further example, a first cleaning member 14 is located above the exterior cylindrical surface 8 of the roller 4 and a second cleaning member 14 is located to the side of the exterior cylindrical surface 8 of the roller.

As indicated in FIG. 1, the cleaning member actuator 24 is controlled by the controller 18 to move the cleaning member 14 back and forth in the direction of arrow 26 between the first and second positions. The cleaning member actuator is of a solenoid type. The sensor 10 is of an optical type, and more specifically is a colour sensor.

In the above-mentioned examples described in relation to FIG. 1, the, or each, cleaning member 14 is a brush. In an alternative example, the cleaning member 14 is an elastic and resiliently deformable wiper element. In a yet further example, the cleaning member 14 has a fibrous material such as a lint-free cloth.

The sensor 10 senses material attached to the roller by reference to the variation in colour detected. The exterior cylindrical surface 8 of the roller 4 has a known colour which is different to the colour (typically a grey/black colour) of build material which sticks or attaches to the exterior cylindrical surface 8. The sensor 10 generates electrical signals based on the colour it senses, and these signals are received and interpreted by the controller 18 to determine the state of cleanliness of the roller 4. The controller 18 compares the area of exterior cylindrical surface 8 having the known colour of the exterior cylindrical surface 8. Any area not having the known colour is considered to be dirty (for example, covered in build material or other contaminant material). If a sufficient area does not have the known colour (i.e. a predetermined threshold of contaminant on the roller 4 is exceeded), then the controller determines that the amount of build material or other contaminant material on the exterior cylindrical surface 8 is unacceptable and needs to be cleaned from the roller 4.

A method of cleaning an exterior surface of a moveable spreader of an additive manufacturing machine is shown in FIG. 1. The method uses a sensor 10 to sense the presence of material 12 attached to the exterior surface 8 of the spreader 4. In response to the sensor 10 sensing the presence of material 12 attached to the exterior surface 8 of the spreader 4, the spreader 4 is moved adjacent a cleaning member 14 to clean the attached material 12 from the exterior surface 8 of the spreader 4.

The cleaning member 14 is moved from a storage position to a position adjacent the spreader 4 in response to the sensor 10 sensing the presence of material 12 attached to the exterior surface 8 of the spreader 4.

The spreader 4 is moved to a storage position prior to the sensor 10 sensing the presence of material 12, the sensor 4 sensing the presence of material 12 attached to the exterior surface 8 of the spreader 4 once the spreader 4 is in the storage position. The storage position of the spreader 4 is spaced from the print zone and is where the spreader 4 is located (or parked) when not spreading build material. The spreader 4 is located in its storage position when a print nozzle is in use.

The controller 18 is adapted, or provided with instructions, to perform the above-mentioned method. The controller 18 determines the presence of material 12 attached to the exterior surface 8 of the spreader 4. In response to the determination of material 12 being attached to the exterior surface 8 of the spreader 4, the controller 18 controls the spreader 4 to move adjacent a cleaning member 14 to clean the attached material 12 from the exterior surface 8 of the spreader 4.

The controller 18 controls the cleaning member 14 to move the cleaning member 14 between a storage position and a position adjacent the spreader 4. The controller 18 controls the cleaning member 14 to move the cleaning member 14 from a storage position to a position adjacent the spreader 4 in response to the controller 18 determining the presence of material 12 attached to the exterior surface 8 of the spreader 4.

The controller 18 controls the spreader 4 to move the spreader 4 to a storage position prior to the controller 18 operating the sensor 10 to sense the presence of material 12. The controller 18 controls the sensor 4 to sense the presence of material 12 attached to the exterior surface 8 of the spreader 4 once the spreader 4 is in the storage position.

The controller 18 is adapted to control operation of the sensor 4. Also, the controller 18 is adapted to receive signals from the sensor 4 which are indicative of the presence of attached material, and to determine if the spreader 4 requires cleaning. The controller 18 is adapted to control movement of the spreader 4. The controller 18 is adapted to control movement of the cleaning member actuator 24 and therefore of the cleaning member 14.

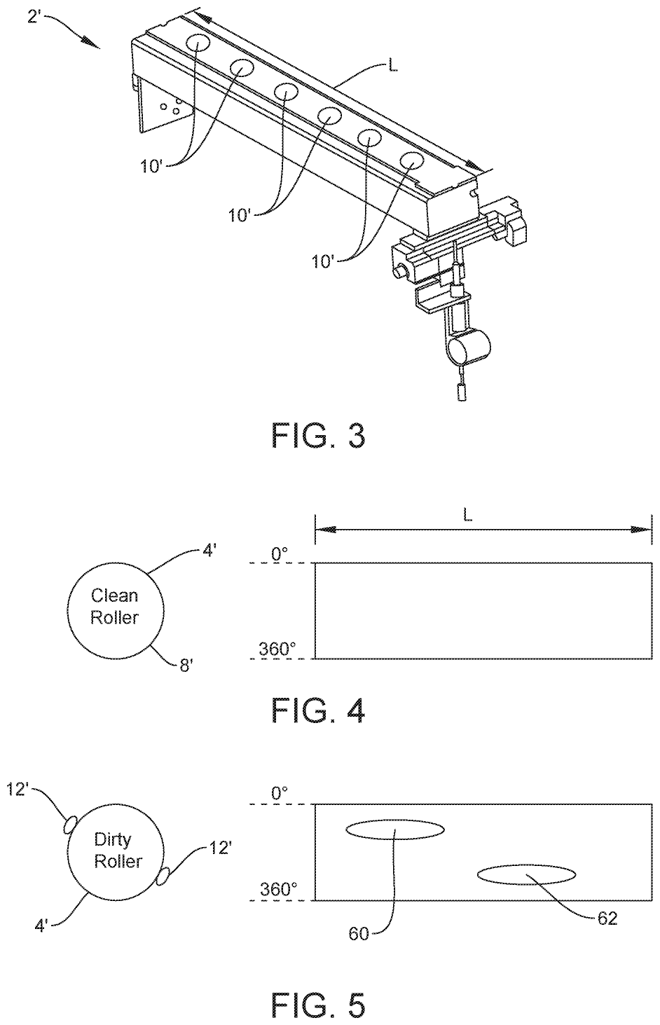

A spreading system 2′ of an additive manufacturing machine 30′ in accordance with aspects of the present disclosure is shown in FIG. 2. Components of this spreading system 2′ are shown in FIGS. 3 to 7. The spreading system 2′ has features corresponding to those of the schematic spreading system shown in FIG. 1, and corresponding features are denoted with like reference numerals in the accompanying drawings. By way of example, the system of FIG. 1 has a roller 4, and the system of FIGS. 2 and 3 has a spreader 4′.

In FIG. 2, a perspective view of the spreader 4′ of the spreading system 2′ is shown circled. The spreader 4′ is mounted between rails 32 which are themselves mounted within the additive manufacturing machine 30′ and allow the spreader 4′ to move back and forth over a print area 34 in the direction indicated by arrow 36. The print area 34 is provided on a mobile build unit 38 which is moveable on wheels 40 in to a position between the rails 32. Once a printing operation is complete, the build unit 38 is removed from between the rails 32, together with the printed work, so that the printed work can be subjected to post printing processing. Meanwhile, another build unit can be moved into position between the rails 32 for a further printing operation to take place.

Only the build unit 38 and spreading system 2′ are shown in FIG. 2, the remainder of the additive manufacturing machine 30′ not being shown for the sake of clarity and simplicity.

In another example, the build unit and additive manufacturing machine are integral with one another. In such an example, the functions of the build unit and additive manufacturing machine are performed by a single unit.

FIG. 3 shows a perspective view of part of the spreading system 2′ wherein the location of sensors 10′ is schematically shown. In one example, the presence of material stuck or otherwise attached to the spreader 4′ is sensed with six sensors 10′. The sensors 10′ are spaced equidistant along the length L of the spreader 4′. In one example, the spacing between the sensors 10′ is approximately 5 cm and the length of the spreader is 30 cm. In other examples, the length of the spreader is up to 40 cm and additional sensors 10′ are provided to ensure the full length of the spreader is sensed with sensors having a spacing of approximately 5 cm. So, for a spreader of 40 cm length, eight sensors 10′ are used.

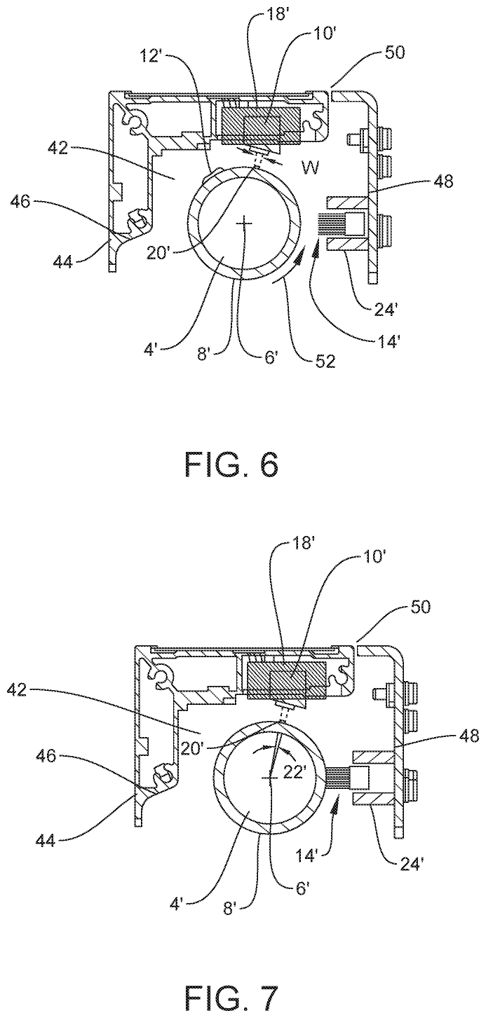

A cross-sectional end view of part of the spreading system 2′ is shown in FIG. 6 with a cleaning member 14′ located in a first position. A similar cross-sectional end view of part of the spreading system 2′ is shown in FIG. 7, but with a cleaning member 14′ located in a second position.

FIGS. 6 and 7 show the spreader as a roller 4′ rotatable about an axis 6′ and having an exterior cylindrical surface 8′ to spread build material. The roller 4′ is located within a space 42 of a two-piece housing 44. The housing 44 has a first piece 46 and a second piece 48, the two pieces 46,48 meeting along an abutment line 50 and being separable from one another to allow access to the space 2.

The first piece 46 has the six sensors 10′ mounted thereto. Only one sensor 10′ is shown in FIGS. 6 and 7. The sensors 10′ are of an optical type and, more specifically, are colour sensors.

The sensors 10′ are mounted above the rotary axis 6′ of the roller 4′ and oriented so that the exterior cylindrical surface 8′ passes through their field of view 20′ as the roller 4′ rotates. In this way, material 12′ which is stuck or otherwise attached to the exterior cylindrical surface 8′ is sensed by the sensors 10′ as the roller 4′ rotates and the attached material 12′ is thereby moved through the field of view 20′ of the sensors 10′. The field of view 20′ of each sensor 10′ extends at least sufficiently along the length of the roller 4′ to ensure that sensors 10′ combine to cover the full length of the roller 4′. Accordingly, with a spacing of 5 cm between neighbouring sensors 10′, the field of view 20′ of each sensor extends at least 5 cm along the length of the roller 10′.

The elongate field of view 20′ of the sensor has a width (W) equal in dimension to a circumferential portion of the exterior cylindrical surface 8′ which extends through an arc 22′ of 1 degree. In alternative examples, the arc is between 1 and 3 degrees. The field of view 20′ of each sensor 10′ has an elongate shape. More specifically, the field of view 20′ of each sensor 10′ has a generally rectangular shape. The combined field of view of the six sensors has a generally rectangular shape with a long side having a length L approximately equal to the length of the roller 4′ and having width (W).

A controller 18′ is also mounted to the first piece 46. In an alternative example, the controller 18′ is located elsewhere in the additive manufacturing machine 30′. The controller 18′ rotates the roller 4′ as the exterior cylindrical surface 8′ is sensed by the sensors 10′, operates the sensors 10′, receives measurement information from the sensors 10′ and uses this information to determine the amount of attached material 12 present on the exterior cylindrical surface 8′, compares the determined amount with a predetermined threshold amount of attached material, and actuates the brush 14′ depending upon whether or not the predetermined threshold amount is exceeded.

The brush 14′ and an associated brush actuator 24′ are mounted on the second piece 48 of the housing 44 and to the side of the roller 4′. The brush actuator 24′ is operated so that the brush 14′ is moved in the space 42 between a first position, in which the brush 14′ is stored (see FIG. 6), and a second position, in which the brush 14′ is actuated (see FIG. 7). The actuator 24′ is of a solenoid type.

In an alternative example, a further brush 14′ and associated brush actuator 24′ are mounted on the first piece 46 of the housing 44 and above the roller 4′.

In the first position, the brush 14′ is spaced from the exterior cylindrical surface 8′. In the second position, the brush 14′ is adjacent or abutting the exterior cylindrical surface 8′ so that the brush 14′ contacts material 12′ attached to the exterior cylindrical surface 8′ as the roller 4′ rotates past the brush 14′ (as indicated by arrow 52 in FIG. 6). In this way, the brush 14′ removes material 12′ from the roller 4′. Once the exterior cylindrical surface 8′ is free from material 12′ attached thereto, as confirmed by the sensors 10′, the brush actuator 24′ moves the brush 14′ from the second position (FIG. 7) to the first position (FIG. 6).

In use of the additive manufacturing machine 30′, the cleanliness of the roller 4′ is determine and ensured once the roller 4′ has performed its build material spreading function across the build area 34 and has returned along the rails 32 back to its parked or stored position (clear of, and no longer above, the build unit 38), as shown in FIG. 2. Once the roller 4′ is located in the parked position, the sensors 10′ sense the amount of material 12′ attached to the exterior cylindrical surface 8′. This is achieved by the controller 18′ moving the roller 4′ through a complete (sensing) rotation (i.e. a rotation of 360 degrees). In this way, the whole of the exterior cylindrical surface 8′ is passed through the field of view 20′ of the sensors 10′.

The controller 18′ records a measurement from sensors 10′ for every 1 degree of rotation of the roller 4′. Given that the sensors 10′ have a field of view with a width (W) covering an arc 22′ of 1 degree, the controller records 360 separate measurements for each of the six sensors 10′ during a single roller rotation. This then allows the amount of the exterior cylindrical surface 8′ covered with attached material 12′ to be determined by the controller 18′. In the example shown, this determination is made by the controller 18′ first mapping the location of any attached material 12′ on the exterior cylindrical surface 8′. An example of dirty roller 4′ is shown in FIG. 5 with first and second areas 60, 62 of attached material 12′ having been mapped. If the combined areas 60, 62 of the exterior cylindrical surface 8′ having material 12′ attached thereto is in excess of 5% of the total area of the exterior cylindrical surface 8′ of the roller 4′, then the controller 18′ determines the exterior cylindrical surface 8′ to be dirty and in need of cleaning (see FIG. 5). Upon such determination, the controller 18′ actuates the brush 14′, moving the brush 14 from the first position to the second position.

With the brush 14′ adjacent or abutting the exterior cylindrical surface 8′, the controller 18′ again rotates the roller 4′ through one complete (cleaning) rotation. In alternative examples, the roller 4′ is rotated through two or more rotations. In rotating the roller 4′ with the brush 14 actuated, the brush 14′ brushes against the material 12′ attached in areas 60,62 and removes (or begins to remove) this material 12′ from the roller 4′.

Once the cleaning rotation has been completed, the controller 18′ moves the roller 4′ through another sensing rotation to again determine whether or not the amount of attached material 12′ is in excess of the predetermine threshold. If the cleaning rotation has been successful in removing attached material 12′ with the brush 14′, then the roller 4′ will be deemed ready for further operation in spreading build material. If the roller 4′ is entirely clean, then mapping (by the controller 18′) of exterior cylindrical surface 8′ will be entirely clear of areas having attached material 12′, as shown in FIG. 4. If the cleaning rotation has not been successful in removing attached material 12′ with the brush 14′, then the roller 4′ will be subjected to another cleaning rotation and a subsequent further sensing rotation. This is repeated a predetermined number of times or until the cleaning rotation has been successful in removing attached material 12′ with the brush 14′.

As described above, the cleaning rotation and subsequent sensing rotation (to confirm the effectiveness of the cleaning) are performed separately. However, in an alternative example, the controller 18′ performs the cleaning rotation and sensing rotation simultaneously, with the sensors 10′ sensing the exterior cylindrical surface 8′ as it is being brushed by the brush 14′. In this case, the brushing continues until the controller 18′ determines the threshold to be no longer exceeded or until a predetermined period of time spent brushing has been completed.

The controller 18′ uses cylindrical projection equations similar to those used generally in cartography to generate the flat 2-Dimensional colour maps shown in FIGS. 4 and 5 from the measurements of sensors 10′.

The controller 18′ allows for the 5% threshold to be changed either manually by a user or automatically in dependence upon, for example, the type of build material being used.

The example shown in FIGS. 6 and 7 has a single brush 14′ which extends along the full length of the roller 4′. In an alternative example, a plurality of separate brushes are provided along the full length of the roller 4′. The separate brushes are moved simultaneous by a single actuator or are each moved by separate actuators, each brush having a separate actuator associated with it.

Accordingly, an additive manufacturing machine 30′ is provided, the machine 30′ having a build material spreading system 2′, wherein the spreading system has a moveable spreader 4′ with an exterior surface 8′ to spread build material; a sensor 10′ to sense material 12′, which material is attached to the exterior surface 8′ of the spreader 4′; a brush 14′ to contact material attached to the exterior surface 8′ of the spreader 4′ and to remove the attached material from the exterior surface 8′; and a controller 18′ to move the spreader 4′ relative to the brush 14′ to thereby contact the brush 14′ with material attached to the exterior surface 8′ of the spreader 4′, the spreader 4′ being so moved in response to the sensor 10′ sensing material 12′ attached to the exterior surface 8′ of the spreader 4′.

Build material may comprise any suitable form of build material, for example short fibres, granules or powders. A powder may include short fibres that may, for example, have been cut into short lengths from long strands or threads of material. The build material can include thermoplastic materials, ceramic material and metallic materials. Binders may include chemical binder systems, such as in Binder Jet or metal type 3D printing. Binders or fusing agents may be used as appropriate.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

What is claimed is:

1. A spreading system for an additive manufacturing machine, comprising:
a roller rotatable about a rotary axis and comprising an exterior cylindrical surface to spread build material;
a sensor to sense material attached to the exterior cylindrical surface of the roller;
a cleaning member to abut the exterior cylindrical surface of the roller and remove attached material therefrom; and
a controller to rotate the roller whilst in abutment with the cleaning member in response to the sensor sensing material attached to the exterior cylindrical surface of the roller.

2. The spreading system of claim 1, wherein the controller rotates the roller in response to the sensor sensing material attached to the exterior cylindrical surface of the roller in excess of a predetermined threshold amount of attached material.

3. The spreading system of claim 2, wherein the predetermined threshold amount of attached material is an area of the exterior cylindrical surface of the roller covered by attached material in the range of 5% to 15% of the total area of the exterior cylindrical surface of the roller.

4. The spreading system of claim 2, wherein the controller rotates the roller through 360 degrees to determine whether material attached to the exterior cylindrical surface of the roller is in excess of the predetermined threshold amount of attached material.

5. The spreading system of claim 4, wherein the sensor senses material located in an elongate field of view of the sensor, the field of view comprising a length at least the length of the roller and wherein the controller rotates the exterior cylindrical surface of the roller through the field of view to determine the amount of material attached to the exterior cylindrical surface.

6. The spreading system of claim 5, wherein the elongate field of view of the sensor has a width equal in dimension to a circumferential portion of the exterior cylindrical surface which extends through an arc of between 1 and 3 degrees.

7. The spreading system of claim 5, further comprising a cleaning member actuator to move the cleaning member between a first position, in which the cleaning member is stored, and a second position, in which the cleaning member abuts the exterior cylindrical surface of the roller.

8. The spreading system of claim 7, wherein the cleaning member actuator moves the cleaning member from the first position to the second position, or retains the cleaning member in the second position, in response to the sensor sensing material attached to the exterior cylindrical surface of the roller in excess of the predetermined threshold amount of attached material.

9. The spreading system of claim 8, wherein the cleaning member actuator is controllable to move the cleaning member from the second position to the first position, or retain the cleaning member in the first position, in response to the sensor sensing material attached to the exterior cylindrical surface of the roller is at or below the predetermined threshold amount of attached material.

10. The spreading system of claim 9, wherein the sensor senses material attached to the exterior cylindrical surface of the roller while the controller rotates the roller in abutment with the cleaning member, and wherein the cleaning member actuator moves the cleaning member from the second position to the first position in response to the sensor sensing material attached to the exterior cylindrical surface of the roller is at or below the predetermined threshold amount of attached material.

11. The spreading system of claim 10, wherein the cleaning member is located above and/or to the side of the exterior cylindrical surface of the roller.

12. A method of cleaning an exterior surface of a moveable spreader of an additive manufacturing machine, comprising:
using a sensor to sense the presence of material attached to the exterior surface of the spreader; and
in response to the sensor sensing the presence of material attached to the exterior surface of the spreader, moving the spreader adjacent a cleaning member to clean the attached material from the exterior surface of the spreader.

13. The method of claim 12, wherein the cleaning member is moved from a storage position to a position adjacent the spreader in response to the sensor sensing the presence of material attached to the exterior surface of the spreader.

14. The method of claim 13, wherein the spreader is moved to a storage position prior to the sensor sensing the presence of material, the sensor sensing the presence of material attached to the exterior surface of the spreader once the spreader is in the storage position.

15. An additive manufacturing machine comprising a build material spreading system, wherein the spreading system comprises:
a moveable spreader comprising an exterior surface to spread build material;
a sensor to sense material, which material is attached to the exterior surface of the spreader;
a brush to contact material attached to the exterior surface of the spreader and to remove the attached material from the exterior surface; and
a controller to move the spreader relative to the brush to thereby contact the brush with material attached to the exterior surface of the spreader, the spreader being so moved in response to the sensor sensing material attached to the exterior surface of the spreader.
